(19) United States
(12) Patent Application Publication
(10) Pub. No.: US 2025/0309286 A1
(43) Pub. Date: Oct. 2, 2025

(54) FUEL CELL STACK AND WELDING METHOD

(71) Applicant: Honda Motor Co., Ltd., Tokyo (JP)

(72) Inventors: Kei Matsumoto, Tokyo (JP); Kazuyuki Sanda, Tokyo (JP); Satoshi Oyama, Tokyo (JP); Toru Ikeda, Tokyo (JP)

(21) Appl. No.: 19/063,212

(22) Filed: Feb. 25, 2025

(30) Foreign Application Priority Data
Mar. 29, 2024 (JP) 2024-058107

(51) Int. Cl. H01M 8/0297; B23K 31/02; H01M 8/0206; H01M 8/0254; H01M 8/1004

(52) U.S. Cl. CPC H01M 8/0297; B23K 31/02; H01M 8/0206; H01M 8/0254; H01M 8/1004

(57) ABSTRACT

A fuel cell stack including a joined separator, and a membrane electrode structure including a membrane electrode assembly disposed between a pair of the joined separators, the membrane electrode assembly including an electrolyte membrane and an electrode. The joined separator includes a first metal separator and a second metal separator welded together along a welding line, and the second metal separator includes a convex portion formed along the welding line so as to protrude toward the first metal separator.

### CROSS-REFERENCE TO RELATED APPLICATION

This application is based upon and claims the benefit of priority from Japanese Patent Application No. 2024-058107 filed on Mar. 29, 2024, the content of which is incorporated herein by reference.

### BACKGROUND OF THE INVENTION

### Field of the Invention

This invention relates to a fuel cell stack and a welding method of a joined separator included in the fuel cell stack.

### Description of the Related Art

In recent years, technological developments have been made on a fuel cell that contribute to energy efficiency in order to ensure access to energy that is affordable, reliable, sustainable and advanced by more people. As a technology related to this type of fuel cell, a fuel cell stack formed by stacking a plurality of power generation cells is known. The power generation cell includes a membrane electrode assembly and a pair of metal separators arranged to sandwich the membrane electrode assembly. For example, in the fuel cell stack described in Japanese Unexamined Patent Publication No. 2023-150887 (JP 2023-150887 A), a joint separator is used, which is formed by welding adjacent metal separators of neighboring power generation cells into a single unit.

Conventionally, when metal separators are welded and connected, welding is performed while clamping a pair of metal separators with a clamp jig such that a gap is not generated in a welding portion due to undulation or the like. In this case, it is preferable to clamp flat portions around both sides of a welding line in order to ensure contact between the metal separators in the welding line.

However, in order to narrow the welding portion, there may be no space to clamp the flat portions depending on a welding spot. For example, when a bead portion is provided close to the welding line, it is necessary to perform welding by clamping the bead portion due to the space. However, when the bead portion is clamped, it is difficult to ensure contact in the welding line.

### SUMMARY OF THE INVENTION

An aspect of the present invention is a fuel cell stack including a joined separator, and a membrane electrode structure including a membrane electrode assembly disposed between a pair of the joined separators, the membrane electrode assembly including an electrolyte membrane and an electrode. The joined separator includes a first metal separator and a second metal separator welded together along a welding line, and the second metal separator includes a convex portion formed along the welding line so as to protrude toward the first metal separator.

### BRIEF DESCRIPTION OF THE DRAWINGS

The objects, features, and advantages of the present invention will become clearer from the following description of embodiments in relation to the attached drawings, in which:

FIG. 1 is an exploded perspective view illustrating one of a plurality of power generation cells constituting a fuel cell stack according to an embodiment of the present invention;

FIG. 2 is an enlarged view of a region surrounded by a broken line C in FIG. 1;

FIG. 3 is a cross-sectional view taken along line A-A of FIG. 2;

FIG. 4 is a diagram illustrating a shape of a welding region for a first and second metal separators;

FIG. 5 is a diagram illustrating a clamping method when laser welding is performed;

FIG. 6 is a diagram illustrating a state where bead portions are clamped;

FIG. 7 is a diagram illustrating a modification of FIG. 4;

FIG. 8 is a diagram illustrating a modification of FIG. 7;

FIG. 9 is a diagram illustrating another modification of FIG. 4;

FIG. 10 is a diagram illustrating a modification of FIG. 9;

FIG. 11 is a diagram illustrating a state where a convex portion is formed in each of a pair of metal separators; and

FIG. 12 is a diagram illustrating another example of asymmetrical convex shape.

### DETAILED DESCRIPTION OF THE INVENTION

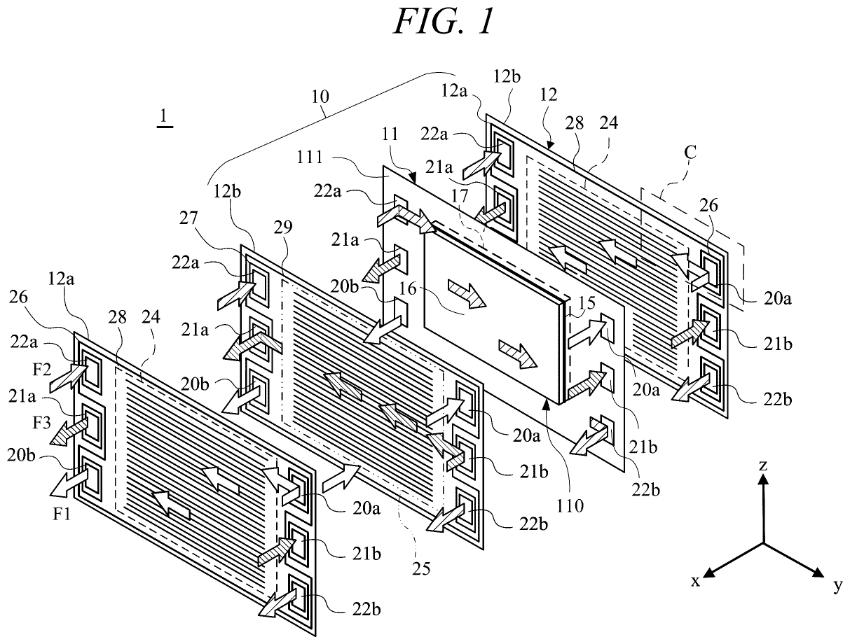

Hereinafter, embodiments of the present invention will be described with reference to FIGS. 1 to 12. FIG. 1 is an exploded perspective view illustrating one of a plurality of power generation cells 10 constituting a fuel cell stack 1 according to an embodiment of the present invention. In FIG. 1, three axial directions orthogonal to each other are indicated as an x-axis direction, a y-axis direction, and a z-axis direction. As illustrated in FIG. 1, the plurality of power generation cells 10 are stacked in the x-axis direction, and a fastening load (compressive load) is applied to the fuel cell stack 1 after stacking the power generation cells 10 in a stacking direction. For example, the fuel cell stack 1 is mounted on an electric vehicle that travels by power of a fuel cell as an in-vehicle fuel cell stack.

The power generation cell 10 includes a unitized electrode assembly (hereinafter, referred to as the UEA) 11, and a first metal separator 12a and a second metal separator 12b disposed on both sides of the UEA 11. The UEA 11 includes a membrane electrode assembly (hereinafter, referred to as the MEA) 110 and a frame member 111 joined to a peripheral edge portion of the MEA 110. The UEA 11 may be referred to as a membrane electrode structure. The MEA 110 includes an electrolyte membrane 15, an anode electrode 16 provided on one surface of the electrolyte membrane 15, and a cathode electrode 17 provided on the other surface of the electrolyte membrane 15. The first metal separator 12a and the second metal separator 12b are formed by press-molding a metal thin plate, and have a corrugated cross-sectional shape. As the metal thin plate, for example, a steel plate, a stainless steel plate, an aluminum plate, a titanium thin plate, or a metal thin plate obtained by subjecting these to a surface treatment for corrosion prevention is used.

In a pair of power generation cells 10 adjacent to each other, the first metal separator 12a of one power generation cell 10 and the second metal separator 12b of the other power generation cell 10 are integrally joined by welding. Hereinafter, a member obtained by welding and joining the first metal separator 12a and the second metal separator 12b will be referred to as a joined separator 12. That is, in the fuel cell stack 1, a plurality of UEAs 11 and a plurality of joined separators 12 are alternately stacked.

In the example illustrated in FIG. 1, the power generation cell 10 is disposed such that a long side direction is the y-axis direction and a short side direction is the z-axis direction. Each of the UEA 11, the first metal separator 12a, and the second metal separator 12b of the power generation cell 10 is provided with an oxidant gas inlet communication hole 20a, a cooling medium inlet communication hole 21b, and a fuel gas outlet communication hole 22b at an end portion on a plus side in the y-axis direction. The oxidant gas inlet communication holes 20a, the cooling medium inlet communication holes 21b, and the fuel gas outlet communication holes 22b formed in each of the UEA 11, the first metal separator 12a, and the second metal separator 12b communicate with each other in the stacking direction (x-axis direction).

The oxidant gas inlet communication hole 20a, the cooling medium inlet communication hole 21b, and the fuel gas outlet communication hole 22b are arranged side by side in the z-axis direction. The oxidant gas inlet communication hole 20a is a communication hole for supplying oxidant gas (for example, oxygen-containing gas). The cooling medium inlet communication hole 21b is a communication hole for supplying a cooling medium (for example, water). The fuel gas outlet communication hole 22b is a communication hole for discharging fuel gas (for example, hydrogen-containing gas).

Each of the UEA 11, the first metal separator 12a, and the second metal separator 12b of the power generation cell 10 is provided with a fuel gas inlet communication hole 22a, a cooling medium outlet communication hole 21a, and an oxidant gas outlet communication hole 20b at an end portion on a minus side in the y-axis direction. The fuel gas inlet communication holes 22a, the cooling medium outlet communication holes 21a, and the oxidant gas outlet communication holes 20b formed in each of the UEA 11, the first metal separator 12a, and the second metal separator 12b communicate with each other in the stacking direction (x-axis direction).

The fuel gas inlet communication hole 22a, the cooling medium outlet communication hole 21a, and the oxidant gas outlet communication hole 20b are arranged side by side in the z-axis direction. The fuel gas inlet communication hole 22a is a communication hole for supplying oxidant gas. The cooling medium outlet communication hole 21a is a communication hole for discharging a cooling medium. The oxidant gas outlet communication hole 20b is a communication hole for discharging oxidant gas.

In FIG. 1, an arrow F1 represents a flow of oxidant gas, an arrow F2 represents a flow of the fuel gas, and an arrow F3 represents a flow of a cooling medium. The disposition of the oxidant gas inlet communication hole 20a and the oxidant gas outlet communication hole 20b, and the fuel gas inlet communication hole 22a and the fuel gas outlet communication hole 22b is not limited to the present embodiment, and may be appropriately set according to required specifications.

An oxidant gas flow path 24 extending in a longitudinal direction (y-axis direction) is formed on a surface of the first metal separator 12a facing the UEA 11. First bead portions 26 and 28 formed by press molding are formed on a surface of the first metal separator 12a facing the UEA 11. The first bead portions 26 and 28 are bank-shaped convex portions protruding in the direction of the UEA 11. Although not illustrated, a resin material fixed by printing, coating, or the like is provided on top portions of the first bead portions 26 and 28. The resin material enhances adhesion between the first bead portions 26 and 28 and the frame member 111, and functions as a sealing material.

The first bead portion 26 is formed so as to individually surround each of the communication holes 20a, 20b, 21a, 21b, 22a, and 22b. The first bead portion 28 is formed so as to surround a region surrounded by the oxidant gas flow path 24 and the first bead portion 26 and provided with the communication holes 20a, 20b, 22a, and 22b. The oxidant gas flows into the oxidant gas flow path 24 from the oxidant gas inlet communication hole 20a, flows through the oxidant gas flow path 24 toward the minus side of the y axis, and then is discharged from the oxidant gas outlet communication hole 20b.

As indicated by a two-dot chain line, a fuel gas flow path 25 extending in the longitudinal direction (y-axis direction) is formed on a surface of the second metal separator 12b facing the UEA 11. Second bead portions 27 and 29 formed by press molding are formed on a surface of the second metal separator 12b facing the UEA 11. The second bead portions 27 and 29 are bank-shaped convex portions protruding in the direction of the UEA 11. Although not illustrated, a resin material fixed by printing, coating, or the like is provided on top portions of the second bead portions 27 and 29. The resin material enhances adhesion between the second bead portions 27 and 29 and the frame member 111, and functions as a sealing material.

The second bead portion 27 is formed so as to individually surround each of the communication holes 20a, 20b, 21a, 21b, 22a, and 22b. The second bead portion 29 is formed so as to surround a region surrounded by the fuel gas flow path 25 and the second bead portion 27 and provided with the communication holes 20a, 20b, 22a, and 22b. The fuel gas flows into the fuel gas flow path 25 from the fuel gas inlet communication hole 22a, flows through the fuel gas flow path 25 toward the plus side of the y axis, and then is discharged from the fuel gas outlet communication hole 22b.

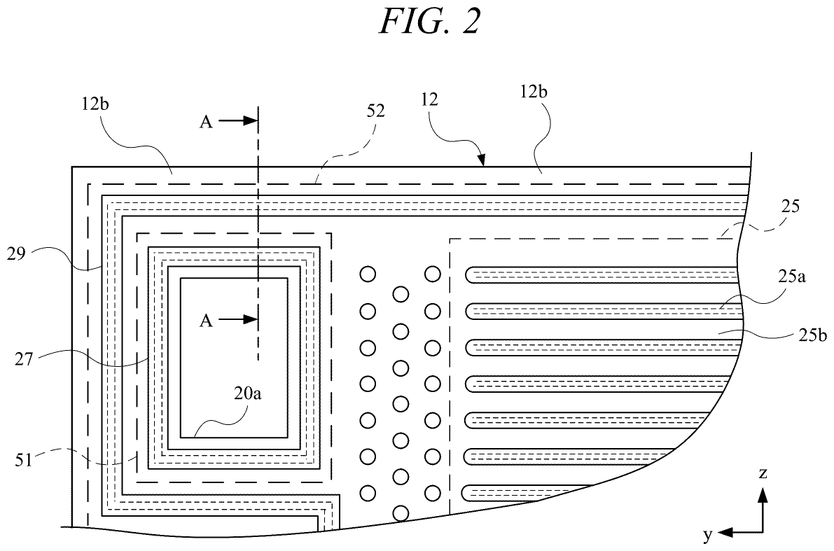

FIG. 2 is an enlarged view of a region surrounded by a broken line C of the joined separator 12 illustrated in FIG. 1 as viewed from the minus side of the x axis. That is, FIG. 2 illustrates a surface of the second metal separator 12b facing the UEA 11. The fuel gas flow path 25 includes a flow path groove 25b between a plurality of convex portions 25a extending in the longitudinal direction (y-axis direction). Although not illustrated, the oxidant gas flow path 24 also includes a flow path groove between a plurality of convex portions extending in the (y-axis direction) similarly to the case of the fuel gas flow path 25. The first metal separator 12a and the second metal separator 12b constituting the joined separator 12 are joined by laser welding, and are joined to each other at welding lines 51 and 52 indicated by broken lines.

As illustrated in FIG. 2, the welding line 51 is set so as to surround the second bead portion 27 around the oxidant gas inlet communication hole 20a. The welding line 52 is set so as to surround the second bead portion 29. Around the oxidant gas inlet communication hole 20a, the second bead portion 27 and the second bead portion 29 function as two rows of metal bead seals adjacent to each other at a narrow interval.

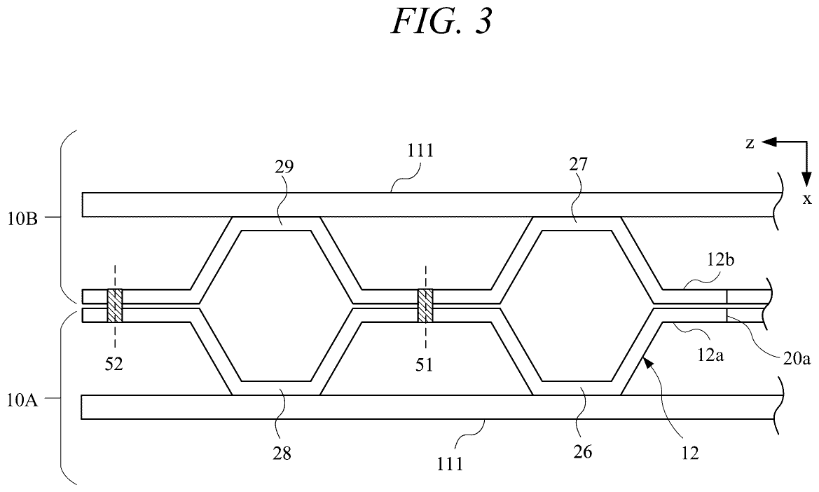

FIG. 3 is a cross-sectional view taken along the line A-A in FIG. 2. The joined separator 12 includes the first metal separator 12a that is a component of a power generation cell 10A and the second metal separator 12b that is a component of a power generation cell 10B. The first bead portions 26 and 28 of the first metal separator 12a protrude toward the frame member 111 of the power generation cell 10A. The second bead portions 27 and 29 of the second metal separator 12b protrude toward the frame member 111 of the power generation cell 10B.

In the fuel cell stack 1, a fastening load (compressive load) in the stacking direction is applied. Therefore, the first bead portions 26 and 28 and the second bead portions 27 and 29 are pressed against the frame members 111 of the UEAs 11 of the opposed power generation cells 10A and 10B, respectively. The first metal separator 12a and the second metal separator 12b are laser-welded in the welding lines 51 and 52.

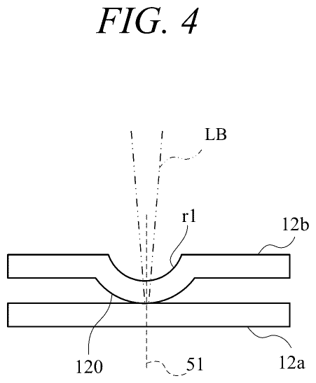

FIG. 4 is a diagram illustrating the shapes of the first metal separator 12a and the second metal separator 12b in the welding line 51 of FIG. 3, and is an enlarged view of a welding region including the welding line 51. FIG. 4 illustrates the shape of each of the metal separators 12a and 12b before welding, and a dashed line represents the position of the welding line 51. A shape of a welding region including the welding line 51 of the first metal separator 12a is a flat plate shape.

On the other hand, in the welding line 51 of the second metal separator 12b, a convex portion 120 protruding toward the first metal separator 12a is formed by press working. The convex portion 120 is formed along the welding line 51. In the example illustrated in FIG. 4, the convex portion 120 is formed in an arc-shaped convex portion having a radius r1 in a cross section orthogonal to the welding line 51. By irradiating the welding line 51 with a laser beam as indicated by a two-dot chain line LB, the metal separators 12a and 12b are welded and joined.

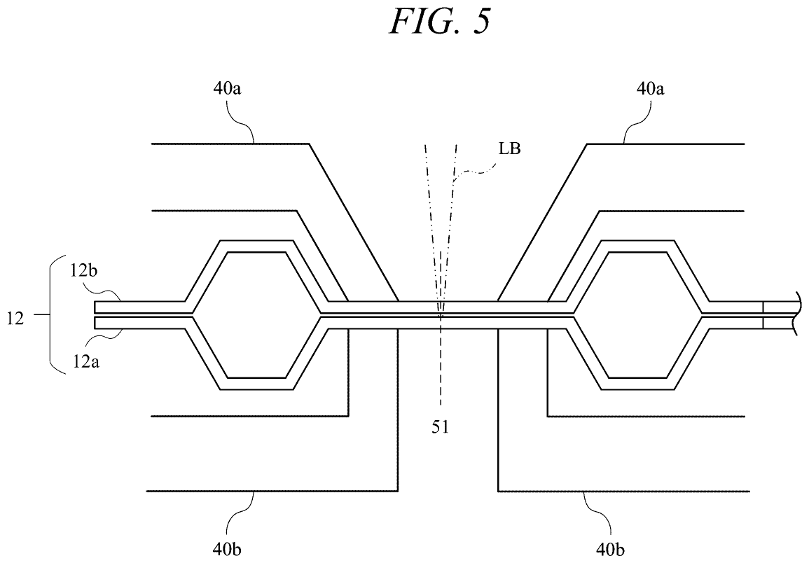

When the pair of metal separators 12a and 12b is welded, it is necessary to bring the first metal separator 12a and the second metal separator 12b in the welding region into contact with each other without a gap in order to perform appropriate welding. Therefore, when laser welding is performed, as illustrated in FIG. 5, flat regions on both sides of the welding line 51 are generally clamped by clamp jigs 40a and 40b. In a state where the metal separators 12a and 12b are clamped in this manner, the welding line 51 is irradiated with a laser beam as indicated by the two-dot chain line LB, and the metal separators are welded and joined.

However, in the welding line 51 in a region where the interval between the second bead portion 27 and the second bead portion 29 is narrow as in the periphery of the oxidant gas inlet communication hole 20a in FIG. 2, it is difficult to secure clamping places in flat regions on both sides of the welding line 51. In such a case, welding should be performed by clamping the bead portion instead of the flat region. However, when the bead portion is clamped, since the metal separator is very thin, the metal separator is deformed by the clamp, and a gap is likely to be generated in the flat region. Therefore, it is difficult to secure contact in the entire region along the welding line, and a portion where contact cannot be secured partially occurs. As a result, welding performance varies, and appropriate welding cannot be performed over the entire region along the welding line.

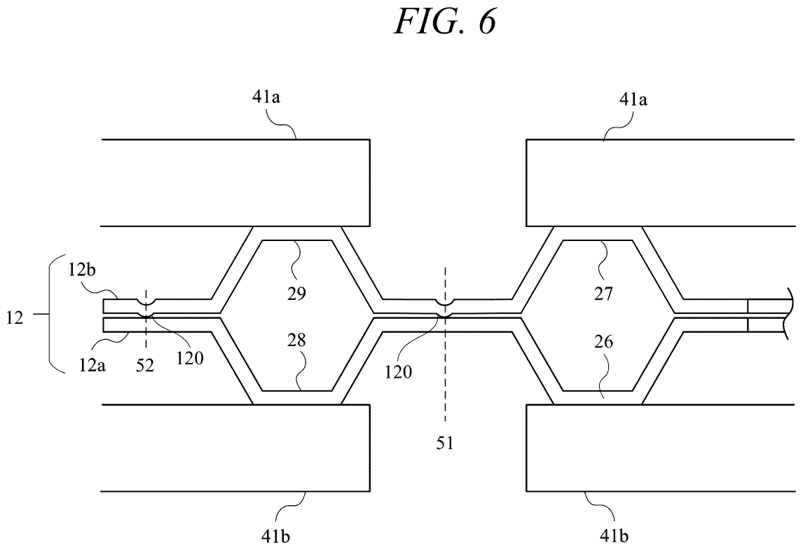

In the present embodiment, as illustrated in FIG. 4, the second metal separator 12b is provided with the convex portion 120 protruding toward the first metal separator 12a. Therefore, even when the bead portions 26 and 28 and the bead portions 27 and 29 are clamped by the clamp jigs 41a and 41b as illustrated in FIG. 6, the convex portion 120 of the second metal separator 12b and the flat region of the first metal separator 12a reliably come into contact with each other. Therefore, by forming the convex portion 120 along the welding line 51, it is possible to reliably prevent a welding failure from occurring.

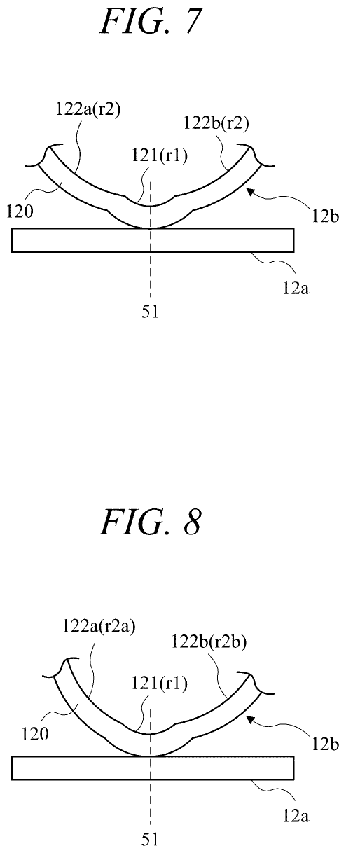

FIG. 7 is a diagram illustrating a modification of FIG. 4. That is, similarly to the case of FIG. 4, FIG. 7 is an enlarged view of a welding region including the welding line 51 of FIG. 3, and illustrates the shape of each of the metal separators 12a and 12b before welding. The welding region of the first metal separator 12a has a flat plate shape, similarly to FIG. 4. On the other hand, the convex portion 120 of the second metal separator 12b includes a first arc region (portion) 121 including the tip of the convex portion, and second arc regions (portions) 122a and 122b continuously connected to both ends of the first arc region 121.

In FIG. 7, radii r1 and r2 of the first arc region 121 and the second arc regions 122a and 122b are indicated in parentheses for convenience. The radius r1 of the first arc region 121 and the radius r2 of the second arc regions 122a and 122b are set to satisfy a relationship of r1<r2. The convex portion 120 in FIG. 7 may be formed in a part of the flat region between the bead portions 27 and 29 including the welding region, or may be formed in the entire flat region. That is, the entire flat region is defined as the second arc region 122 having the radius r2, and the center portion thereof is defined as the first arc region 121 having the radius r1.

As described above, when the fuel cell stack 1 is formed by stacking the plurality of power generation cells 10, the plurality of power generation cells 10 are compressed in the stacking direction. By forming the second arc regions 122a and 122b having a larger radius so as to be continuous with the first arc region 121, the spring constant against the compressive deformation can be increased, the pressing force in the bead portions 26 to 29 is increased, and the sealing property is improved. Since the radii r1 and r2 satisfy the relationship of r1<r2, the second arc regions 122a and 122b are more easily deformed than the first arc region 121. Therefore, when the metal separators 12a and 12b are compressed, the second arc regions 122a and 122b are deformed, so that the deformation of the first arc region 121 as a welding portion can be suppressed. As a result, it is possible to prevent the welding portion from being removed (the welding spot from being separated).

In FIG. 7, the radii r2 of the second arc regions 122a and 122b are equal to each other. However, as illustrated in FIG. 8, a radius r2a of the second arc region (portion) 122a and a radius r2b of the second arc region (portion) 122b may have different values. In the example of FIG. 8, r2a<r2b is satisfied. Therefore, the rigidity when the bead portion is compressed is larger in the second arc region 122a than in the second arc region 122b. By setting the radius r2a and the radius r2b to different values in this manner, the rigidity of the left and right bead portions against compression can be individually set. Although the arc-shaped convex portion 120 having the radius r1 is illustrated in FIG. 4, the convex portion 120 may be configured as an asymmetrical convex portion 120 by an arc surface 120a having the radius r1 and an arc surface 120b having the radius r2 (<r1) as illustrated in FIG. 12. The arc surface 120a having the radius r1 is continuously formed on the slope of the bead portion 29 (FIG. 6), and the arc surface 120b having the radius r2 is continuously formed on the slope of the bead portion 27 (FIG. 6). Also in this case, the rigidity of the left and right bead portions against compression can be individually set.

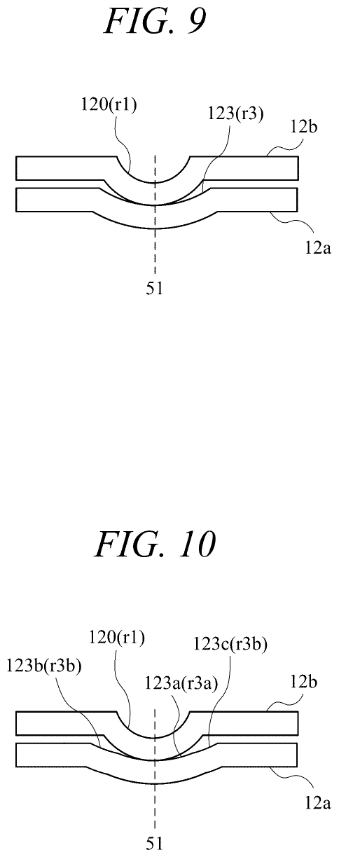

FIG. 9 is a diagram illustrating another modification of FIG. 4. In FIG. 9, the shape of the convex portion 120 of the second metal separator 12b is similar to that in the case illustrated in FIG. 4, but the shape of the welding region of the first metal separator 12a is different from that in the case illustrated in FIG. 4. In the first metal separator 12a of FIG. 9, a concave portion 123 recessed with respect to the convex portion 120 of the second metal separator 12b is formed. The concave portion 123 is formed along the welding line 51, and is formed in an arc-shaped concave portion in a cross section orthogonal to the welding line 51. A radius r3 of the concave portion 123 is set to a value (r1<r3) larger than the radius r1 such that the tip of the convex portion 120 having the radius r1 comes into contact with the bottom of the concave portion 123 in the welding line 51. Also in the example of FIG. 9, it is possible to reliably ensure the contact between the convex portion 120 of the second metal separator 12b and the concave portion 123 of the first metal separator 12a, and it is possible to reliably prevent a welding failure. Furthermore, since the convex portion is in contact with the concave portion, it is possible to prevent the separators from being displaced in the lateral direction.

As illustrated in FIG. 10, the concave portion 123 of the first metal separator 12a may be configured by two arc regions (portions) having different radii, similarly to the case of the convex portion 120 in FIG. 7. In FIG. 10, a bottom center region of the concave portion 123 is constituted by a first arc region (portion) 123a having a radius r3a, and second arc regions (portions) 123b and 123c having a radius r3b are provided so as to be continuous with both ends of the first arc region 123a. The radii r3a and r3b are set to satisfy a relationship of r3a<r3b. Therefore, the second arc regions 123b and 123c are more easily deformed than the first arc region 123a, and deformation of the first arc region 123a as a welding portion is suppressed when the bead portion is compressed. As a result, it is possible to prevent the welding portion from being removed.

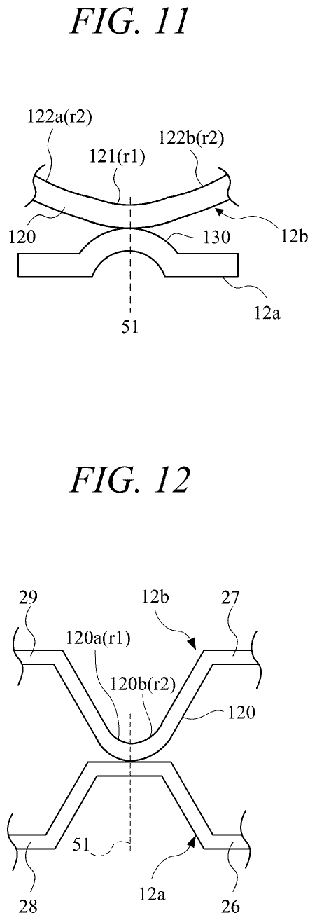

In the embodiment and the modifications described above, the convex portion 120 is formed on the second metal separator 12b, but the convex portion 120 may be formed on the first metal separator 12a. In FIG. 9, the convex portion 120 is formed on one metal separator, and the concave portion 123 is formed on the other metal separator. However, as illustrated in FIG. 11, the convex portion 130 may be formed on the other metal separator. The second metal separator 12b in FIG. 11 has the convex portion 120 including the first arc region (portion) 121 and the second arc regions (portions) 122a and 122b, similarly to the second metal separator 12b in FIG. 7. On the other hand, the first metal separator 12a has the convex portion 130 protruding toward the second metal separator 12b at the position of the welding line 51. The convex portion 120 of the second metal separator 12b may have a shape similar to that of the convex portion 120 in FIG. 4.

In the embodiment and the modifications described above, the configurations of the metal separators 12a and 12b in the welding line 51 have been described. Although illustration and description are omitted, the metal separators 12a and 12b in the welding line 52 are also configured similarly to the metal separators 12a and 12b in the welding line 51.

The above embodiment can be combined as desired with one or more of the above modifications. The modifications can also be combined together.

According to the present invention, it is possible to reliably ensure a contact of a pair of metal separators in a welding line.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a joined separator; and
a membrane electrode structure including a membrane electrode assembly disposed between a pair of the joined separators, the membrane electrode assembly including an electrolyte membrane and an electrode, wherein
the joined separator includes a first metal separator and a second metal separator welded together along a welding line, and
the second metal separator includes a convex portion formed along the welding line so as to protrude toward the first metal separator.

2. The fuel cell stack according to claim 1, wherein
when viewed in a cross section orthogonal to the welding line, the convex portion includes a first arcuate convex portion with a tip of the convex portion and second arcuate convex portions seamlessly connected to both ends of the first arcuate convex portion, and
a radius of the second arcuate convex portions is larger than a radius of the first arcuate convex portion.

3. The fuel cell stack according to claim 1, wherein
the first metal separator includes a concave portion configured to face the convex portion along the welding line,
the convex portion and the concave portion are formed in an arcuate shape when viewed in a cross section orthogonal to the welding line, and
a radius of the concave portion is larger than a radius of the convex portion.

4. The fuel cell stack according to claim 3, wherein
when viewed in the cross section, the concave portion includes a first arcuate concave portion including a bottom of the concave portion and second arcuate concave portions seamlessly connected to both ends of the first arcuate concave portion, and
a radius of the second arcuate concave portions is larger than a radius of the first arcuate concave portion.

5. The fuel cell stack according to claim 1, wherein
when viewed in a cross section orthogonal to the welding line, the convex portion includes a first arcuate convex portion on one side of the welding line and a second arcuate convex portion on another side of the welding line, and
a radius of the first arcuate convex portion is different from a radius of the second arcuate convex portion.

6. The fuel cell stack according to claim 1, wherein
when viewed in a cross section orthogonal to the welding line, the convex portion includes a first arcuate convex portion including a tip of the convex portion, a second arcuate convex portion seamlessly connected to one end of the first arcuate convex portion, and a third arcuate convex portion seamlessly connected to another end of the first arcuate convex portion, and
a radius of the second arcuate convex portion is different from a radius of the third arcuate convex portion.

7. The fuel cell stack according to claim 1, wherein
the first metal separator includes first bead portions protruding toward a first direction on both sides of the welding line, and
the second metal separator includes second bead portions protruding toward a second direction opposite to the first direction on the both sides of the welding line.

8. A welding method of a joined separator included in the fuel cell stack according to claim 1, the joined separator including a first metal separator and a second metal separator, each of the first metal separator and the second metal separator including bead portions protruding in opposite directions away from each other on both sides of a welding line,
the welding method comprising
welding the first metal separator and the second metal separator along the welding line while holding the bead portions with a holding jig.
